(19) United States
(12) Patent Application Publication
(10) Pub. No.: US 2017/0216871 A1
(43) Pub. Date: Aug. 3, 2017

(54) Boom Constructed from Several Shaped Panels of Material

(71) Applicant: Specialty Enterprises, LLC, Wautoma, WI (US)

(72) Inventors: Gregory Jackson Klemp, JR., Neshkoro, WI (US); Michael Dennis Peters, West Bend, WI (US); Peter Joseph Heinen, Kewauskum, WI (US)

(73) Assignee: Specialty Enterprises, LLC, Wautoma, WI (US)

(21) Appl. No.: 15/418,499

(22) Filed: Jan. 27, 2017

Related U.S. Application Data
(60) Provisional application No. 62/289,886, filed on Feb. 1, 2016.
(60) Provisional application No. 62/363,807, filed on Jul. 18, 2016.

(51) Int. Cl. B05B 15/06; B05B 13/00

(52) U.S. Cl. CPC B05B 15/064; B05B 13/005

(57) ABSTRACT

The present invention relates to a boom constructed from several shaped panels of material formed or shaped to overlap when assembled to form a strong, yet lightweight, structure. The boom can have two or more joined panels to form a boom with a generally triangular shaped exterior profile. The panels can have two or more lips. One lip from each panel, together with the panel faces, form a six-sided interior profile when the panels are assembled. The interiorly located lips are gussets. The gussets can form three conduits, one at each of the triangle corners. The boom can be tapered along its longitudinal axis. The panels can have ribs formed therein to provide stiffness. A folding assembly (when a secondary section is used) and sprayers can be provided. A structural top tension tube can be provided. Longitudinal ribs that act as flow paths also can be provided.

This patent application claims priority on and the benefit of provisional application 62/289,886 filed Feb. 1, 2016 and provisional application 62/363,807 filed Jul. 18, 2016, which the entire contents of both are hereby incorporated herein by reference.

### BACKGROUND OF THE INVENTION

1. Field of the Invention

The present invention relates to a boom constructed from several shaped panels of material, and in particular to panels formed or shaped to overlap when assembled to form a strong, yet lightweight, structure.

2. Description of the Related Art

Spraying or dispersing of materials over a large area is a challenge in many industries. Using a host vehicle, as opposed to manually dispersing the materials, speeds up the process. Yet, a host vehicle has a limited width and any directly dispersed material from the host vehicle requires many passes to cover a wide area. Wide trailers can be used to increase the width through which material is dispersed. Yet, having many wheels contacting the terrain can present problems. A solution to this is the use of booms that are supported by the host vehicle only that carry and deposit the material over a wide area.

Spraying devices and spray booms are used in many applications and industries. Many manufacturers and products exist to fulfill the needs in these industries.

While each of the existing products may work well for their intended purposes, none have the unique structures and advantages of the present invention.

Thus there exists a need for a boom constructed of several shaped panels of material that solves these and other problems.

### SUMMARY OF THE INVENTION

The present invention relates to a boom constructed from several shaped panels of material formed or shaped to overlap when assembled to form a strong, yet lightweight, structure. The boom can have two or more joined panels to form a boom with a generally triangular shaped exterior profile. The panels can have two or more lips. One lip from each panel, together with the panel faces, form a six-sided interior profile when the panels are assembled. The interiorly located lips accordingly are gussets. The gussets further can form three conduits, one at each of the triangle corners. The boom can be tapered along its longitudinal axis. The panels can have ribs formed therein to provide stiffness on each panel. A folding assembly (when a secondary section is used) and sprayers can be provided. A structural top tension tube can be provided. Longitudinal ribs that act as flow paths also can be provided.

According to one advantage of the present invention, the boom is strong, yet light weight. This advantageously allows the boom to have a long length without undue amounts of weight being supported by the host vehicle. In some applications, such as golf course or turf management, minimizing weight of the host vehicle is a concern as light vehicles do not damage the ground as much as heavy vehicles.

According to another advantage of the present invention, the boom can be made into various lengths. The length (and accordingly spray width) is adjustable when a pivoting secondary section is used. The length is fixed when only a primary section is used. Given the strong and light weight nature of the boom, the boom can have a relatively long length without weight becoming a problem.

According to another advantage of the present invention, the light weight structure can be formed from panels or sheet material. The sheet material, which can be sheet metal, is thin and accordingly light. Yet, when fastened together, the boom structure is quite strong. Further, sheet metal material is relatively easy to work with for stamping and bending.

According to another advantage of the present invention, the constructed boom can have a generally triangular exterior profile. The constructed boom can also have a six-sided interior profile. These profiles, which extend along the longitudinal axis of the boom provide increased resistance to bending, flexing, twisting and impact forces while simultaneously being light weight.

According to another advantage of the present invention, the combination of a generally triangular exterior profile and six-sided interior profile yields three tubes or conduits. These conduits, which are at each corner of the triangle, can be useful for wiring, plumbing or other uses in additional to adding strength to the structure.

According to a still further advantage of the present invention, each panel has a face and two or more lips. The lips have ears to add material in areas where mechanical fasteners are used for increase strength.

According to a still further advantage of the present invention, the three panels could be identically formed panels. In this regard, less parts are required for construction (compared to if three separately shaped panels are used). Also, the resulting boom would generally have the exterior profile of an equilateral triangle.

According to a still further advantage of the present invention, the three panels can be mechanically joined instead of welded. This alleviates welding problems such as cost, complexity and the creation of heat affected zones. It is known that heat affected zones have reduced strength compared to the native material. Extra material is typically required to compensate for the heat affected zones. Yet, the present invention, by virtue of being fastened instead of welded, can take advantage of the full material strength along the length of the boom.

According to a still further advantage of the present invention, sections of the faces can be cut or stamped out to reduce weight. Ribs can be stamped into the panels to add strength and rigidity adjacent or near the cut out sections.

According to a still further advantage of the present invention, the boom can be tapered along its longitudinal axis. The taper could be proportional or otherwise. In this regard, the boom can have increased strength at the proximal end and be lighter at the distal end (outboard tip). Further, a tapered boom adds a level of non-uniformity to the boom to add in rigidity by forming a three-dimensional pyramidal structure.

According to a still further advantage of the present invention, insert members can be located at the ends of the boom and also added along longitudinal locations along the boom. The insert members can aid structural rigidity.

According to a still further advantage of the present invention, the concepts of the present invention allow the booms to be scaled to length, strength and other application requirements across a range of various industries.

According to an advantage of another embodiment of the present invention, the boom can be mechanically fastened (alignment) and adhesively bonded. In a preferred embodiment, the panels riveted together first and adhesively bonded afterwards. This process of the illustrated embodiment advantageously allows for proper spacing, positioning, and fixturing prior to adding adhesives. Adding the adhesive after the device is riveted also eliminates time constraints (due to adhesive curing) in the preliminary boom assembly. Further, strong structures can be achieved without welding and the problems associated therewith (heat affected zones, fatigue cracking, etc.).

According to another advantage of an embodiment the present invention, dimples can be provided in the areas of rivet holes (or elsewhere) to provide a desired and consistent spacing between panels. This allows for even adhesive distribution thickness.

According to a further advantage of an embodiment of the present invention, longitudinal members or longitudinal ribs can be provided to add structural support to the panels and also to provide adhesive flow paths. Adhesive fill holes can be provided in the areas of the longitudinal ribs in order to allow adhesive to be introduced into the ribs wherein it can flow between the panels. The flow path allows the glue or other adhesive to be added after the assembly is riveted together.

According to a still further advantage of an embodiment of the present invention, a top tension tube can be optionally provided to increase strength and rigidity of the boom. The top tension tube is preferably generally trapezoidal in shape. This allows it to nest between the panels adjacent the top of the boom.

According to a still further advantage yet of an embodiment of the present invention, an impact edge can be provided. The impact edge can have a bumper and can be movably and removeably mounted to the bottom of the boom. Having a replaceable member can increase the lifespan of the boom.

According to a still further advantage yet of an embodiment of the present invention, steel end cap assemblies can be provided. The steel end cap assemblies bolt on inside and outside of the truss to carry structural load. In this regard, the assembly sandwiches the end of the aluminum section to result in laminated steel-aluminum-steel structure.

According to a still further advantage of an embodiment of the present invention, the design is modular and serviceable in the field.

According to a still further advantage of an embodiment of the present invention, an electric actuator is provided that is light weight and easily replaceable.

Other advantages, benefits, and features of the present invention will become apparent to those skilled in the art upon reading the detailed description of the invention and studying the drawings.

### BRIEF DESCRIPTION OF THE DRAWINGS

FIG. 1 is a view showing two booms connected to a host vehicle in an intended environment.

FIG. 2 is a perspective view of a preferred embodiment of a boom shown in a retracted position.

FIG. 3 is a perspective view of the embodiment illustrated in FIG. 2 shown in an extended position.

FIG. 4 is a top view of the embodiment illustrated in FIG. 2 shown in a retracted position.

FIG. 5 is a top view of the embodiment illustrated in FIG. 2 shown in an extended position.

FIG. 6 is an end view of the embodiment illustrated in FIG. 2 shown in a retracted position.

FIG. 7 is an opposite end view of the embodiment illustrated in FIG. 2 shown in a retracted position.

FIG. 8 is an exploded isolation view of a preferred embodiment of a primary section.

FIG. 9 is an end view showing a preferred arrangement of three preferred panels of the present invention.

FIG. 9A is similar to FIG. 9, but also shows mechanical fasteners.

FIG. 10 is an exploded view of the embodiment illustrated in FIG. 9.

FIG. 11 is an end view showing an alternative preferred arrangement of three preferred panels of the present invention.

FIG. 12 is an exploded view of the embodiment illustrated in FIG. 11.

FIG. 13 is an end view showing an additional alternative embodiment of the present invention.

FIG. 14 is an end view showing an additional alternative embodiment of the present invention.

FIG. 15 is an exploded view of the embodiment shown in FIG. 14.

FIG. 16 is a perspective view of an alternative embodiment of the present invention.

FIG. 17 is a close-up view of a section of the embodiment illustrated in FIG. 16.

FIG. 18 is a close-up view of a section of the embodiment illustrated in FIG. 16.

FIG. 19 is an end view showing a portion of the embodiment illustrated in FIG. 18.

FIG. 20 is a perspective view showing a secondary section extended from a primary section.

FIG. 21 is a perspective view showing the secondary section retracted and adjacent to the primary section.

FIG. 22 is a perspective view of an optional end cap.

FIG. 23 is an exploded view of the embodiment illustrated in FIG. 22.

FIG. 24 is a partial cross-sectional view showing the end cap sandwiching a portion of the boom truss.

FIG. 25 is a close up view of the embodiment illustrated in FIG. 16.

FIG. 26 is a view showing adjustability of an optional impact edge.

### DETAILED DESCRIPTION OF PREFERRED EMBODIMENTS

While the invention will be described in connection with one or more preferred embodiments, it will be understood that it is not intended to limit the invention to those embodiments. On the contrary, it is intended to cover all alternatives, modifications and equivalents as may be included within the spirit and scope of the invention as defined by the appended claims.

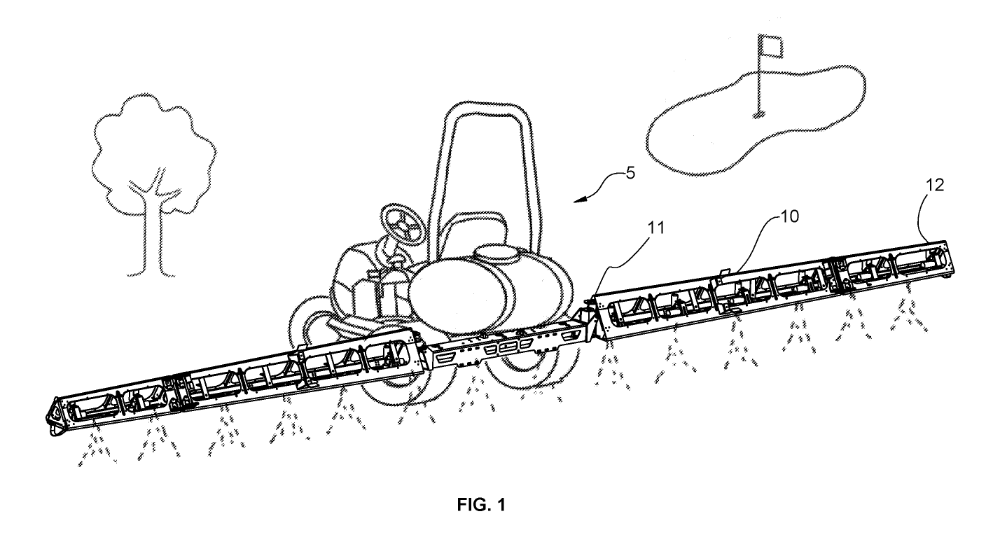

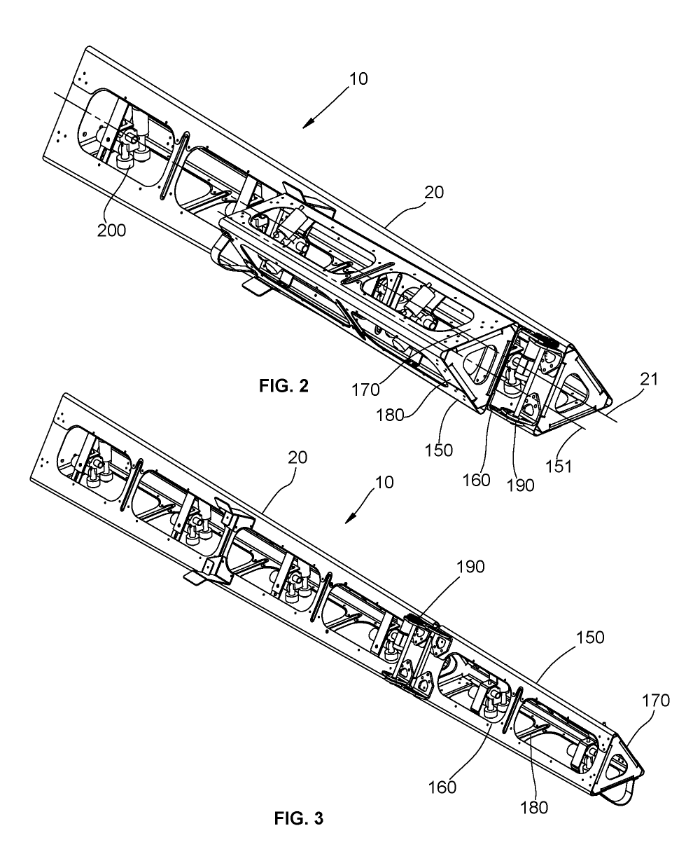

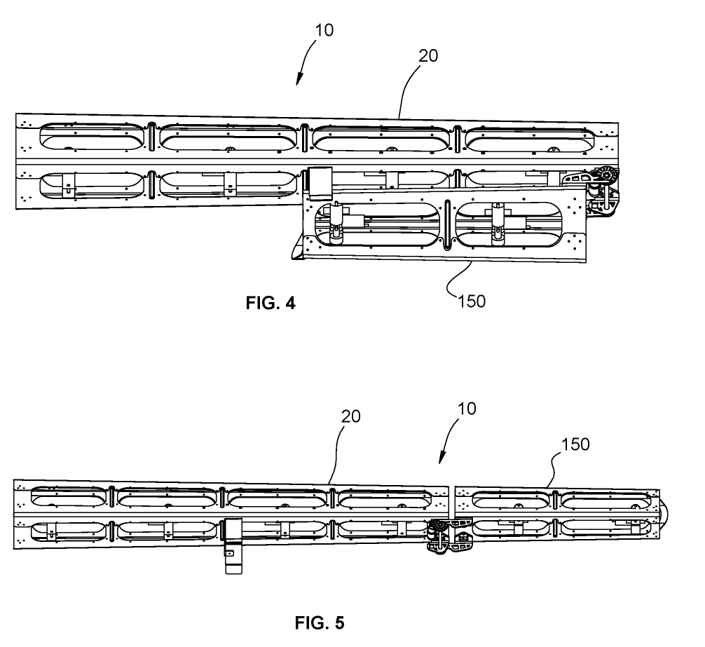

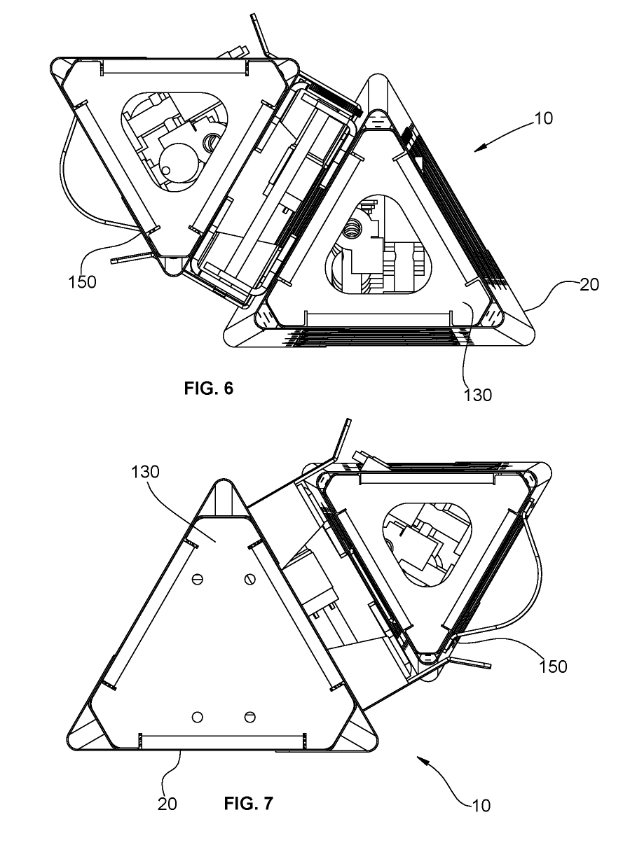

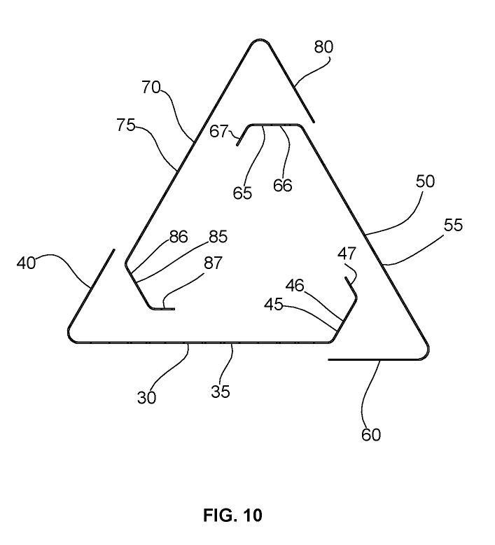

Turning now to FIGS. 1-10, it is seen that a first preferred embodiment of the present invention is illustrated. Two booms 10 are shown in FIG. 1 to be supported by a host vehicle 5. The illustrated booms can be called micro-booms as they are relatively small in length. In this illustrated embodiment, the booms 10 can be used in a golf course or turf management application. Yet, it is understood that the booms can be scaled, designed and manufactured for a large number or applications and industries without departing from the broad aspects of the present invention. Also, the present invention is not limited to use with micro-booms.

The boom 10 has a first end 11 that can be joined to the vehicle 5 and a second end 12 remote from the vehicle. In this regard, end 11 can be proximal the vehicle 5 and end 12 can be distal thereto. A primary section 20 is provided and a secondary section 150 is optionally provided. When a secondary section 150 is provided, it is connected to the primary section 20 with a pivot assembly 190. Sprayers 200 or other material dispersing mechanisms are supported by the boom.

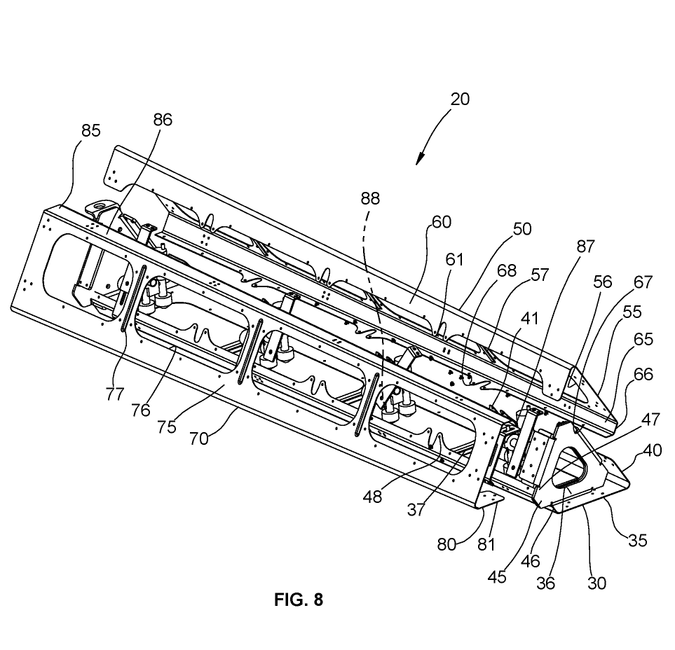

Looking now particularly at FIGS. 8-10, it is seen that the primary section 20 is illustrated. The primary section 20 has a longitudinal axis 21. It is constructed of three panels 30, 50 and 70 of material. One preferred panel is a sheet material, which can be steel, aluminum, composite metal or other materials. Sheet metal is strong and light weight. It is appreciated that other materials can be used without departing from the broad aspects of the present invention.

A first panel 30 is provided having a face 35. Several openings 36 or cutout sections are stamped, cut or otherwise removed from the face 35. The face generally lies in a face plane. Ribs 37 can be laterally formed across the panel and are preferably between the openings 35 generally perpendicular to the longitudinal axis. The openings reduce weight and the ribs increase stiffness. A first lip 40 is provided having ears 41. The lip 40 is formed by bending the panel. Fastening holes are located through the lip at or adjacent to the ears 41. The lip 40 is generally inwardly bent to that it lies in a plane that is generally about 60 degrees from the face plane. A second lip 45 is also provided. The second lip 45 has a first section 46 and a second section 47. The second section has ears 48 with holes there through. The second section is preferably inwardly oriented so that that is lies in a plane that is generally about 60 degrees from the face plane.

A second panel 50 is provided having a face 55. Several openings 56 or cutout sections are stamped, cut or otherwise removed from the face 55. The face generally lies in a face plane. Ribs 57 can be laterally formed across the panel and are preferably between the openings 55 generally perpendicular to the longitudinal axis. The openings reduce weight and the ribs increase stiffness. A first lip 60 is provided having ears 61. The lip 60 is formed by bending the panel. Fastening holes are located through the lip at or adjacent to the ears 61. The lip 60 is generally inwardly bent to that it lies in a plane that is generally about 60 degrees from the face plane. A second lip 65 is also provided. The second lip 65 has a first section 46 and a second section 67. The second section has ears 68 with holes there through. The second section is preferably inwardly oriented so that that is lies in a plane that is generally about 60 degrees from the face plane.

A third panel 70 is provided having a face 75. Several openings 76 or cutout sections are stamped, cut or otherwise removed from the face 75. The face generally lies in a face plane. Ribs 77 can be laterally formed across the panel and are preferably between the openings 75 generally perpendicular to the longitudinal axis. The openings reduce weight and the ribs increase stiffness. A first lip 80 is provided having ears 81. The lip 80 is formed by bending the panel. Fastening holes are located through the lip at or adjacent to the ears 81. The lip 80 is generally inwardly bent to that it lies in a plane that is generally about 60 degrees from the face plane. A second lip 85 is also provided. The second lip 85 has a first section 86 and a second section 87. The second section has ears 88 with holes there through. The second section is preferably inwardly oriented so that that is lies in a plane that is generally about 60 degrees from the face plane.

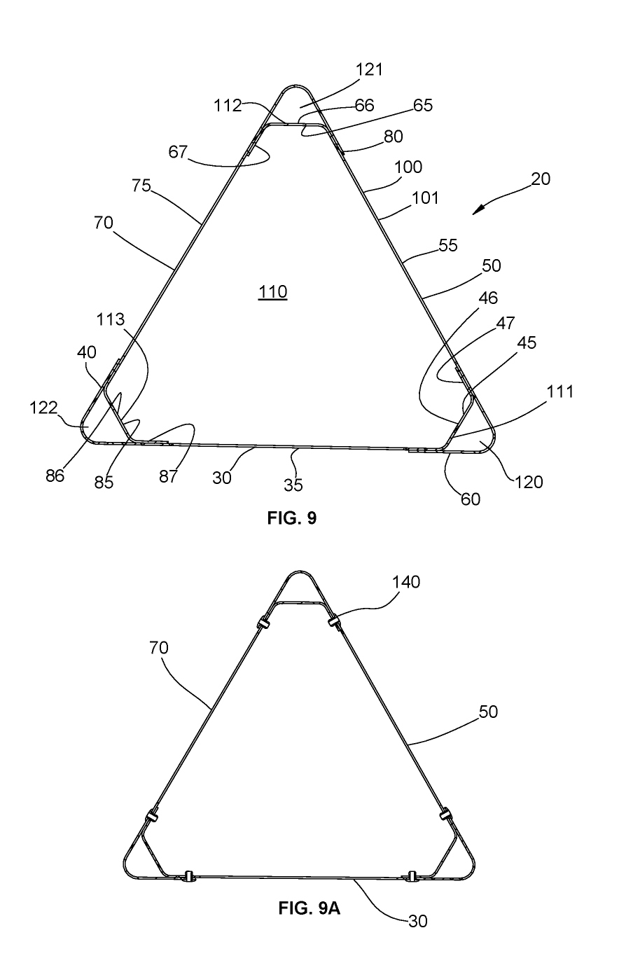

The three panels 30, 50 and 70 are preferably joined with mechanical fasteners 140. An end view showing the placement of the panels 30, 50 and 70 is shown in FIG. 9. Fasteners 140 are illustrated by way of example in FIG. 9A. One preferred type of fastener is a rivet. However, other fasteners such as bolts could be used without departing from the broad aspects of the present invention. It is seen that the respective first lips contact the exterior portions of the faces of the adjacent panels and lie in the same planes therewith in an overlapping or laminated manner. The second sections of the second lips contact the interior portions of the faces of the adjacent panels and lie in the same planes therewith in an overlapping or laminated manner. The first section of each second lip spans between the face and first lip of the adjacent panel. The first section of each second lip is normal to a line that bisects the bent intersection of the face and first lip of the adjacent panel. The respective first lips are on the external portion of the section and the respective second lips are on the internal portion of the primary section.

The three panels 30, 50 and 70 are joined to form in one embodiment an equilateral triangle having an exterior 100 with a wall 101. The primary section 20 is preferably symmetric about lines that bisect the corners of the triangle. An interior 110 is also provided having three gussets 111, 112 and 113 (formed from the first section of the second lip of each panel). The gussets 111, 112 and 113 form three of six sides of an internal polygon structure. The gussets 111, 112 and 113, along with the three corners of the triangle form three conduits 120, 121 and 122. The conduits preferably extend along the entire length of the primary section 20. While described as conduits, these sections could alternatively be pipes, tubes or other structures without departing from the broad aspects of the present invention. Each conduit has a generally triangular shaped profile. Each conduit has an interior wall that lies in a plane that is generally parallel with the plane face of the panel on the opposite side of the primary section. The conduits provide enhance bending strength. The conduits can be used for plumbing, wiring or other uses.

The generally triangular shaped exterior and six-sided interior, along with the conduits, form a strong structure. Insert members 130 can be provided as various locations along the length of the primary section. The insert members 130 are generally arranged perpendicular to the longitudinal axis of the primary section. The insert members can be shaped to mate with the interior portions of the primary section.

The primary section 20 can be tapered along the longitudinal axis 21. In this regard, the conduits can have respective axis that are convergent at or beyond the distal end of the primary section. This creates a pyramidal structure that is structurally rigid. It is understood that the primary section could have constant profile dimensions along the longitudinal axis without departing from the broad aspects of the present invention.

The secondary section 150 has a longitudinal axis 151. The secondary section, if used, can be folded relative to the primary section with a pivot assembly. The folding or pivot assembly can be hydraulic, electric or otherwise without departing from the broad aspects of the present invention. The folding apparatus can be by way of illustration gear or chain driven, linearly actuated or push/pull cable driven, or otherwise driven without departing from the broad aspects of the present invention.

The secondary section 150 has three panels 160, 170 and 180 that are generally fastened in a manner resulting in a generally triangular shaped profile. The secondary section can have a similar profile (internally and externally) as the primary section. The secondary section can also have insert members to enhance structural qualities.

Sprayers 200 can be used to disperse material from the bottom of the boom 10. The sprayers can disperse material through the openings in the bottom panels of the primary and secondary sections.

In a preferred embodiment, the primary section can be about 9 feet in length and the secondary section can be about 3 feet in length (a pair of booms according could be 18 feet without secondary sections or 24 feet with secondary sections). It is understood that these sizes are illustrative only and that they could be longer (even substantially longer) or shorter without departing from the broad aspects of the present invention.

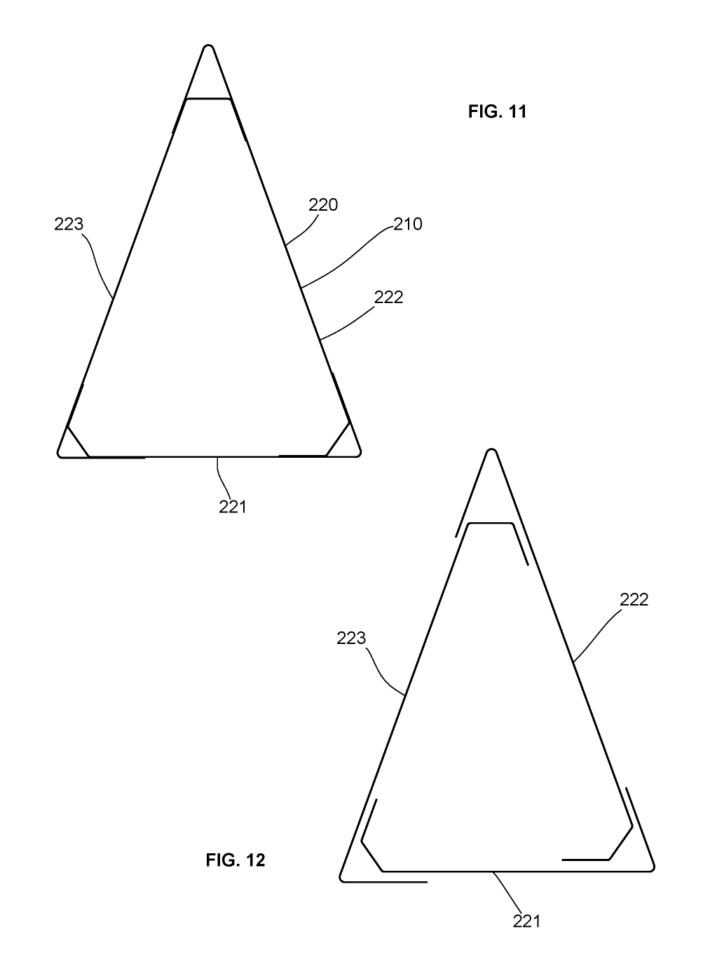

Turning now to FIGS. 11 and 12, it is seen that a boom 210 having a primary section 220 with panels 221, 222 and 223 is provided. In this embodiment, the resultant triangle shaped structure is symmetric about a vertical axis, but is taller than it is wide.

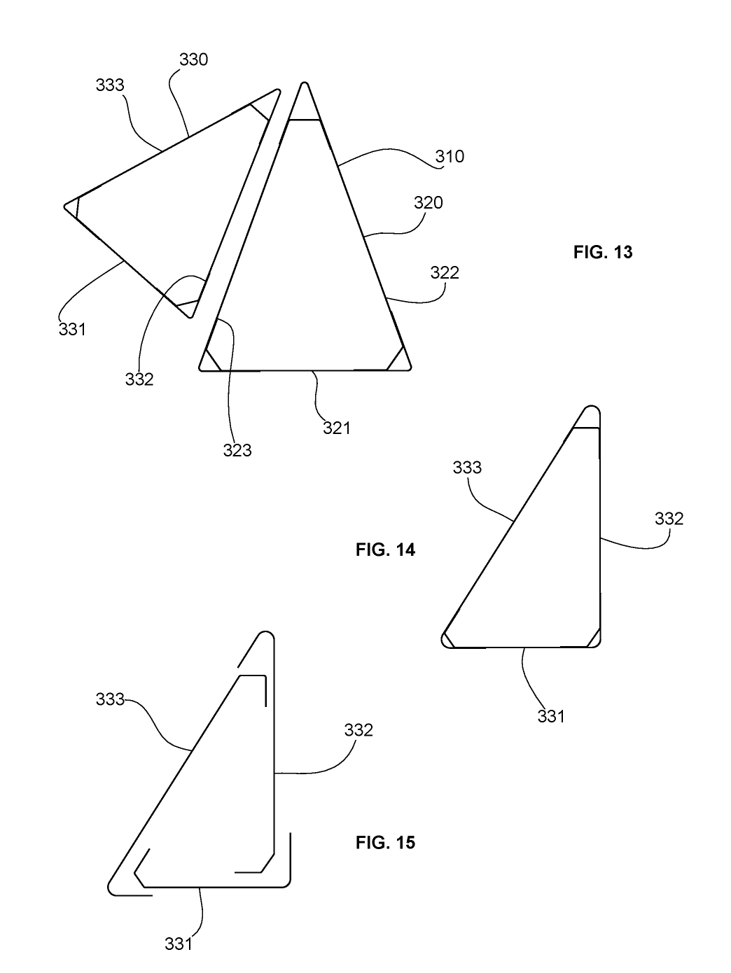

Turning now to FIGS. 13-15, it is seen that a boom 310 with further alternative shaped primary 320 and 330 is provided. The primary section 320 has panels 321, 322 and 323. The primary section has a generally triangular shaped profile that is symmetric about a vertical axis. The secondary section 330 has panels 331, 332 and 333. The secondary section has a generally right triangle shaped profile.

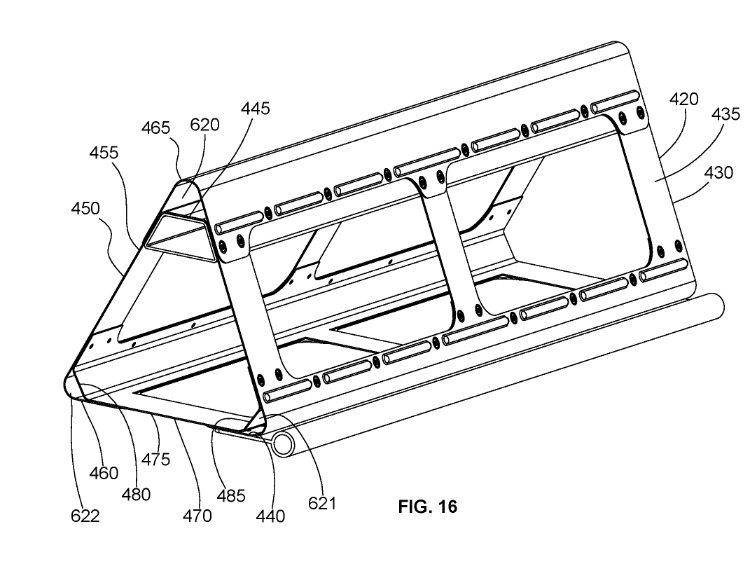

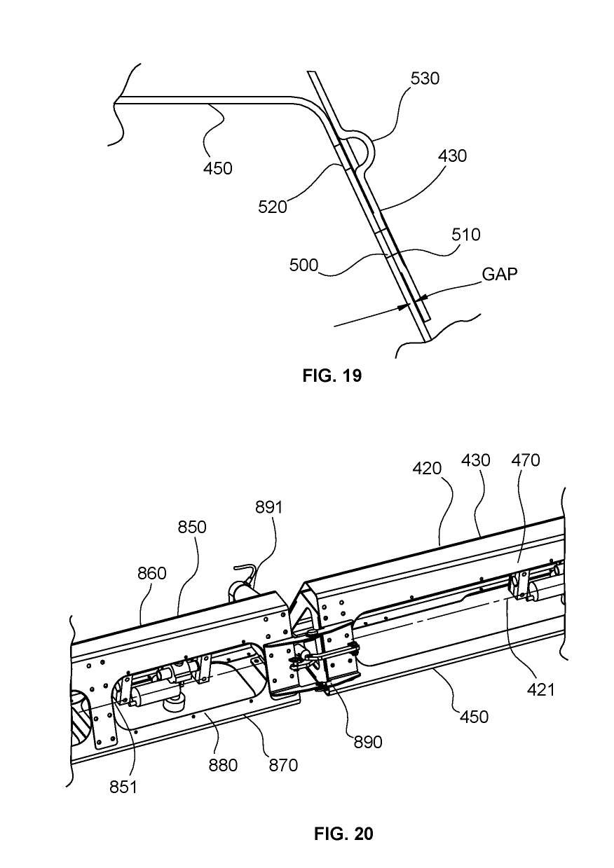

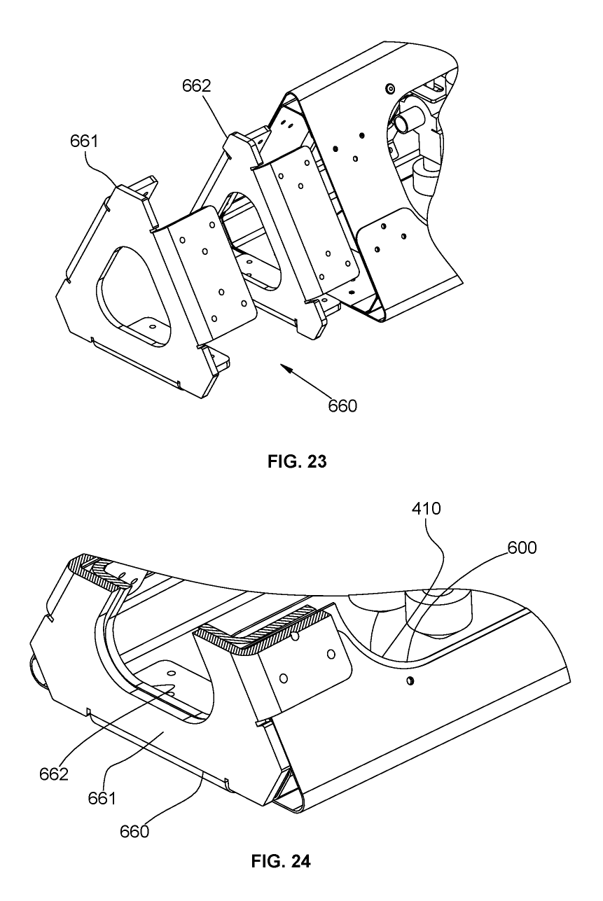

Turning now to FIGS. 16-26, it is seen that several additional features are shown in the illustrated alternative embodiment.

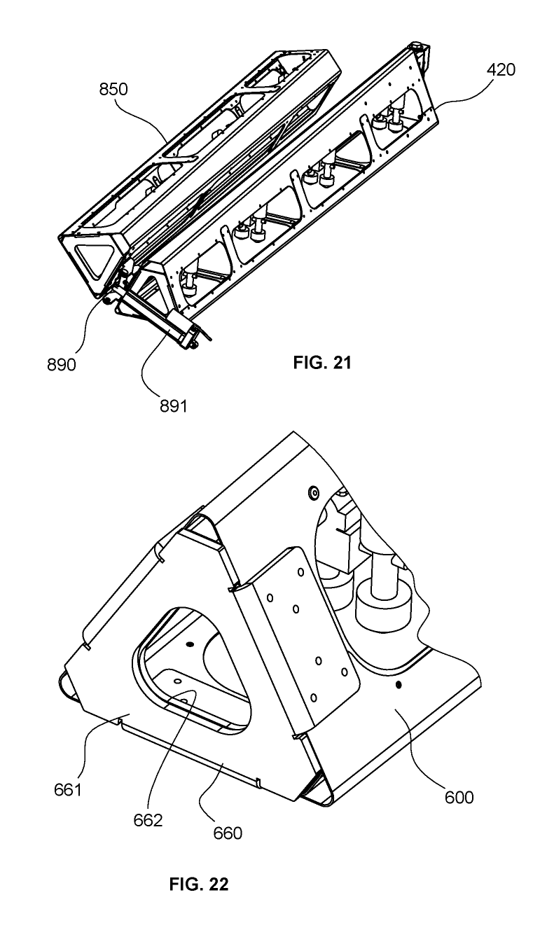

A boom 410 having two ends 411 and 412 is provided. The boom 410 has a primary section 420 with a longitudinal axis 421 and a secondary section 850 with a longitudinal axis 851. The primary or first section 420 and secondary or second section 850 are jointed with a pivot assembly 890 operable with an electric actuator 891 as seen in FIGS. 20 and 21.

The primary section 420 is formed of three panels 430, 450 and 470. Panel 430 has a face 435 and lips 440 and 445. Lips 440 and 445 are at opposite ends of the face 435. Panel 450 has a face 455 and lips 460 and 465. Lips 460 and 465 are at opposite ends of the face 455. Panel 470 has a face 475 and lips 480 and 485. Lips 480 and 485 are at opposite ends of the face.

The panels 430, 450 and 470 are joinable in a manner forming an exterior 600 having a wall 601 with a generally triangular shaped profile. An interior 610 is also provided having three gussets 611, 612 and 613, respectively. The areas between the gussets and the exterior form conduits 620, 621 and 622, respectively. Gusset 611 is a top gusset and forms top conduit 620 along with the panels 430 and 450.

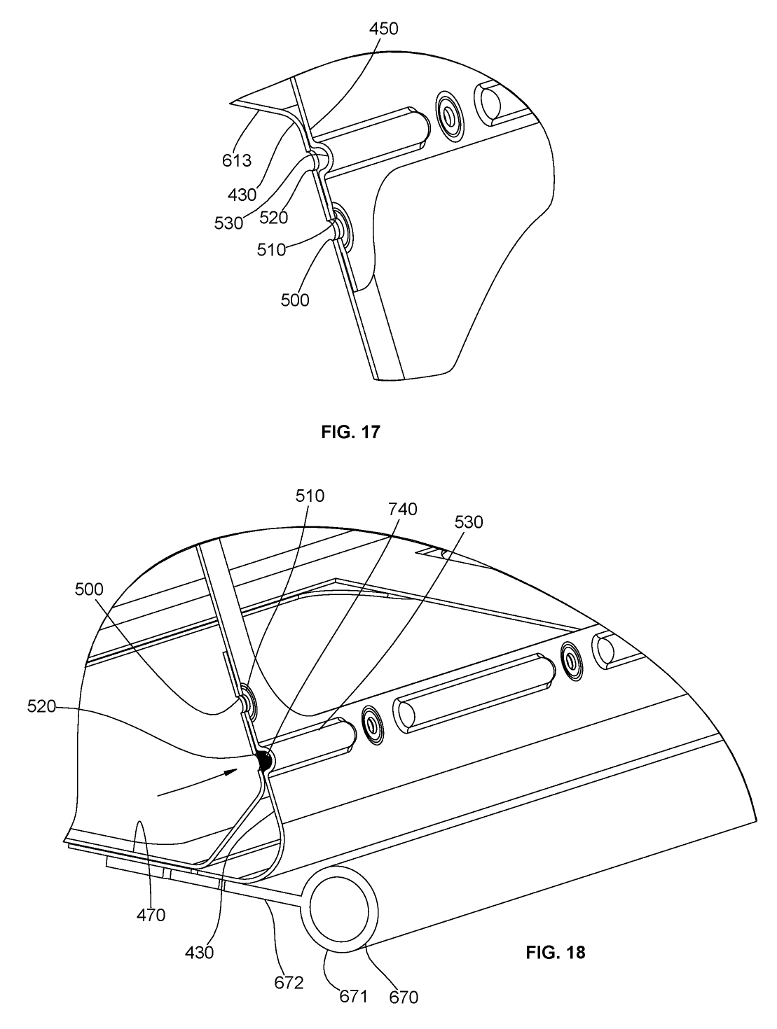

The boom 410 has rivet holes 500 positioned at desired locations on the boom. The rivet holes are placed so that the panels can be joined together. Dimples 510 are provided around the rivet holes 500. The dimples provide a consistent and desired spacing between panels when the panels are joined with rivets. An adhesive fill hole 520 is formed through a panel in the area of an adjacent longitudinal rib or member 530. The hole 520 allows adhesive 740 to be introduced there through and into the rib 530. The rib directs the flow of adhesive longitudinally along the boom. The rib 530 also provides strength and rigidity to the boom. Due to the spacing of the panels (from the dimples, or in an alternative, from other spacing structures) the adhesive also flows between the panels in a consistent and desired manner so that the adhesive can spread to desired areas. Adhesive 740 is illustrated in FIG. 18. The fill hole and panel spacing is illustrated in FIG. 17. In a preferred embodiment, the boom can be formed and attached with rivets (or bolts or other mechanical fasteners) first, and then adhesively joined afterwards.

It is appreciated that alternative structures and methods of panel spacing can be used without departing from the broad aspects of the present invention.

It is appreciated that the strength of the boom in this embodiment results from the adhesively connected panels. In this regard, the mechanical fasteners can primarily be used for alignment (of panels relative to each other) purposes and for clamping (to make sure respective portions of panels remain in close proximity while adhesive is curing) purposes.

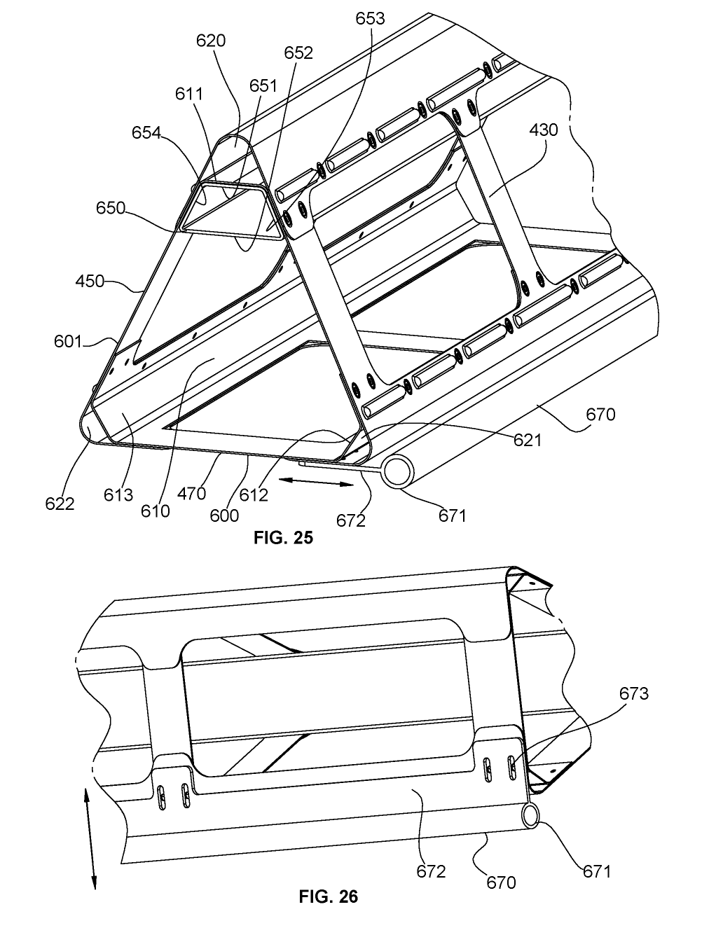

A top tension tube 650 can also be provided. It has a top 651, a bottom 652 and two sides 653 and 654. The sides 653 and 654 are angled resulting in a generally trapezoidal shaped profile. The tube 650 nest between the exterior wall 601 and the top gusset 611. The top tension tube 650 can be useful in situations, such as with longer section lengths, that additional strength and rigidity are needed or desired. The top tension tube 650 is illustrated in FIG. 25. Tube 650 is preferably extruded. Further, it can be riveted and adhesively bonded to the adjacent structures.

Turning now to FIGS. 22-24, it is seen that an embodiment of an end cap 660 is provided. The end cap is comprised of two plates 661 and 662. The plates are preferably made of steel. Yet, other materials can be used without departing from the broad aspects of the present invention. The plates each have lips and can be inserted onto the end of a truss section wherein the plates sandwich the panel ends (as seen in FIG. 24). In this regard, the end cap 660 is a structural member that, when riveted and adhesively bonded, prevent twisting of the end of the boom section and also eliminates stress on the rivet (or bolt) holes. Each plate has two lips that are angled generally perpendicular to the face of the plates, respectively. Each lip is located on a converging surface (convergence at the top of the triangular shaped profile) on a side of the triangular end cap.

Turning now to FIGS. 25 and 26, it is seen that an impact edge 670 is provided. The impact edge 670 has a bumper 671 having a generally round shaped profile. Yet, other shaped profiles can be provided without departing from the broad aspects of the present invention. The geometric and interiorly open profile of the bumper allows it to deform under a load, such as an impact, to absorb the energy thereof. The bumper 671 is at a distal end of a flange 672. One or more slots 673 are at a proximal end of the flange wherein the impact edge 670 is movably (and removably) connected to the bottom side of the boom. The impact edge can be replaced if it becomes damaged. The impact edge 670 is envisioned to be used primarily on the most distal portions of the boom, where risk of impact would be greatest. Yet, it is appreciated that the impact edge 670 could span the entire leading edge of the boom without departing from the broad aspects of the present invention. It is also appreciated that while the bumper is shown to be hollow, it can be filled with a resilient member to aid in the impact absorption and shape retention of the bumper.

Thus it is apparent that there has been provided, in accordance with the invention, a boom constructed from several shaped panels of material that fully satisfies the objects, aims and advantages as set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

We claim:

1. A boom comprising:
a first panel;
a second panel; and
a third panel,
wherein:
said first panel, said second panel and said third panel are joined;
said boom has an exterior that has a generally triangular shaped profile; and
said boom has an interior that has a generally six-sided shaped profile.

2. The boom of claim 1 wherein said boom has a longitudinal length and is tapered along said longitudinal length to form a three-dimensional pyramidal structure.

3. The boom of claim 1 wherein:
said first panel has a first panel face containing at least one first panel rib;
said second panel has a second panel face containing at least on second panel rib; and
said third panel has a third panel face containing at least one third panel rib.

4. The boom of claim 1 wherein:
said first panel has a first panel face, a first panel first lip and a first panel second lip;
said second panel has a second panel face, a second panel first lip and a second panel second lip;
said third panel has a third panel face, a third panel first lip and a third panel second lip;
said first panel first lip overlaps said third panel face;
said second panel first lip overlaps said first panel face;
said third panel first lip overlaps said second panel face;
said boom has a first corner, a second corner and a third corner;
a first conduit being in said first corner;
a second conduit being in said second corner; and
a third conduit being in said third corner.

5. The boom of claim 4 wherein:
said first panel second lip forms a wall of said first conduit;
said second panel second lip forms a wall of said second conduit; and
said third panel second lip forms a wall of said third conduit.

6. The boom of claim 1 wherein said first panel, said second panel and said third panel are identical in shape whereby said generally triangular shaped profile is an equilateral triangle shaped profile.

7. The boom of claim 1 wherein said boom is mechanically fastened and adhesively fastened.

8. The boom of claim 7 wherein a spacer is provided in the area of a mechanical fastener to allow spacing for an adhesive.

9. The boom of claim 8 further comprising at least one longitudinal rib to provide structural support and a longitudinally oriented adhesive flow path.

10. The boom of claim 1 further comprising a top tension tube.

11. The boom of claim 1 wherein:
said third panel is a bottom panel;
said boom further comprises an impact edge movably connected to said bottom panel.

12. The boom of claim 1 further comprising a steel end cap.

13. A boom comprising:
a first panel having a first panel face and a first panel lip;
a second panel having a second panel face and a second panel lip; and
a third panel having a third panel face and a third panel lip,
wherein:
said first panel lip overlaps said third panel face;
said second panel lip overlaps said first panel face;
said third panel lip overlaps said second panel face; and
said boom has a generally triangular shaped exterior profile with a plurality of overlapped wall sections.

14. The boom of claim 13 wherein:
said first panel lip is a first panel first lip, said first panel further having a first panel second lip, wherein said first panel second lip contacts said second panel;
said second panel lip is a second panel first lip, said second panel further having a second panel second lip, wherein said second panel second lip contacts said third panel;
said third panel lip is a third panel first lip, said third panel further having a third panel second lip, wherein said third panel second lip contacts said first panel; and
said boom has a six-sided interior profile.

15. The boom of claim 14 wherein:
said first panel second lip has a first panel second lip first section and a first panel second lip second section, said first panel second lip second section overlapping with said second panel;
said second panel second lip has a second panel second lip first section and a second panel second lip second section, said second panel second lip second section overlapping with said third panel; and
said third panel second lip has a third panel second lip first section and a third panel second lip second section, said third panel second lip second section overlapping with said first panel.

16. The boom of claim 13 wherein said boom has a longitudinal length and is tapered along said longitudinal length to form a three-dimensional pyramidal structure.

17. A boom comprising
a plurality of panels, said plurality of panels comprising:
a first panel;
a second panel; and
a third panel,
wherein:
said first panel, said second panel and said third panel are mechanically fastened in fastening areas for alignment relative to each other wherein said boom has a generally triangular shape exterior profile; and
an adhesive is provided to said fastening areas to bond said plurality of said panels relative to each other.

18. The boom of claim 17 wherein dimples are provided in said fastening areas to allow for introduction of said adhesive.

19. The boom of claim 17 wherein at least one longitudinal bar is provided allowing for a flow area directed along a boom longitudinal axis.

20. The boom of claim 17 wherein said boom has an interior profile that is six-sided.
